(19) United States
(12) Patent Application Publication
(10) Pub. No.: US 2016/0153835 A1
(43) Pub. Date: Jun. 2, 2016

(54) COMB RESOLVED FOURIER TRANSFORM SPECTROSCOPY

(71) Applicant: IMRA America, Inc., Ann Arbor, MI (US)

(72) Inventors: Kevin F. Lee, Ann Arbor, MI (US); Martin E. Fermann, Dexter, MI (US)

(21) Appl. No.: 14/933,334

(22) Filed: Nov. 5, 2015

Related U.S. Application Data
(60) Provisional application No. 62/086,417, filed on Dec. 2, 2014.

(51) Int. Cl. G01J 3/453; G01J 3/10

(52) U.S. Cl. CPC G01J 3/453; G01J 3/108

(57) ABSTRACT

Systems and methods for high resolution and high sensitivity spectroscopy are disclosed. High resolution can be obtained in conjunction with comb sources via comb resolved spectroscopy. For example, Fourier transform spectroscopy with a scan range larger than a cavity round trip time of the comb sources can be used to obtain comb resolution, where it may be useful to match the comb lines of the source with the sampling points of the Fourier transform spectrometer. High sensitivity can be obtained using multiple passes through a gas cell, cavity enhanced spectroscopy, cavity ring-down spectroscopy, or photo-acoustic spectroscopy. Fiber or solid-state lasers as well as semiconductor or quantum cascade based lasers can be used as comb injection sources. These sources can also be combined with nonlinear frequency broadening techniques via supercontinuum generation, DFG, OPOs or OPAs.

### CROSS-REFERENCE TO RELATED APPLICATIONS

The present application claims the benefit of priority to U.S. Provisional Patent Application No. 62/086,417, filed Dec. 2, 2014, titled “COMB RESOLVED FOURIER TRANSFORM SPECTROSCOPY,” which is hereby incorporated by reference herein in its entirety.

### FIELD

The present disclosure relates to high resolution Fourier Transform Spectroscopy.

### BACKGROUND

Advances in frequency measurement methods and systems have occurred over the past several years with the use of optical frequency combs, fiber supercontinuum sources as well as the use of quantum cascade lasers. However, high resolution, broadband measurement in the mid-infrared (mid-IR) spectral region and beyond remains challenging.

### SUMMARY

Various embodiments described in this disclosure relate to high resolution and high sensitivity spectroscopy. High resolution can be obtained in conjunction with comb sources via comb resolved spectroscopy. For example, Fourier transform spectroscopy with a scan range larger than a cavity round trip time of the comb sources can be used to obtain comb resolution, where it may be useful to match the comb lines of the source with the sampling points of the Fourier transform spectrometer. High sensitivity can be obtained using multiple passes through a gas cell, cavity enhanced spectroscopy, cavity ring-down spectroscopy, or photo-acoustic spectroscopy. For cavity enhanced spectroscopy, off axis alignment as well as precision cavity locked arrangements in conjunction with comb injection sources can be implemented. Fiber or solid-state lasers as well as semiconductor or quantum cascade based lasers can be used as comb injection sources. These sources can also be combined with nonlinear frequency broadening techniques via supercontinuum generation, difference frequency generation (DFG), optical parametric oscillators (OPOs), or optical parametric amplifiers (OPAs).

The present disclosure provides examples of a compact system configuration based on frequency combs that can be used for comb line resolved, direct, multipass cell, or cavity enhanced spectroscopy.

Though fiber frequency combs comprise a particularly useful implementation, any form of frequency combs can be employed. For example frequency combs based on quantum cascade lasers, micro-resonators, or other mode locked lasers can be used. Mode locked lasers based on fiber, semiconductor or solid-state technology can be implemented. Appropriate amplification stages can further be used to increase the output power of these sources for greater detection sensitivity.

To shift the spectral output of the modelocked lasers into a spectral region of interest, frequency shifting means such as supercontinuum generation, difference frequency generation (DFG) and optical parametric oscillators (OPO), or amplifiers can be used. In some implementations, frequency shifting does not need to preserve coherence or the comb structure of the source to enable highly sensitive trace gas detection.

Spectral detection can be performed with conventional Fourier transform spectrometers. If the spectrometer optical path delay is sufficiently long to measure the interference of a pulse with itself, and also with a neighboring pulse, the spectrometer will be able to resolve comb modes with appropriate analysis. A spectrum with frequency resolved comb modes samples the spectrum at spectral positions separated by the comb spacing. To gain information about the spectrum or the actual line shape of molecular absorption lines, the carrier envelope offset frequency of the frequency comb can be scanned.

Cavity enhanced spectroscopy can be used for comb resolved spectroscopy, and other detection modalities such as for example multi-pass cells can also be used.

Other detection modalities can be based on photo-acoustic spectroscopy. Broad band photo-acoustic spectroscopy is of particular interest.

### BRIEF DESCRIPTION OF THE DRAWINGS

FIG. 1 schematically illustrates an example of an optical spectroscopy system in conjunction with a multi-pass cell.

FIG. 2 schematically illustrates an example of the principle of operation of comb resolved spectroscopy.

FIG. 3 schematically illustrates an example of optimum overlap of optical comb lines with the location of sampling frequencies in frequency space in a Fourier transform spectrometer

FIG. 4 schematically illustrates an example of a system for photo-acoustic spectroscopy.

FIG. 5 schematically illustrates an alternative example system for photo-acoustic spectroscopy (PAS).

FIG. 6 schematically illustrates an example of a system incorporating a supercontinuum source for cavity-enhanced spectroscopy.

### DETAILED DESCRIPTION

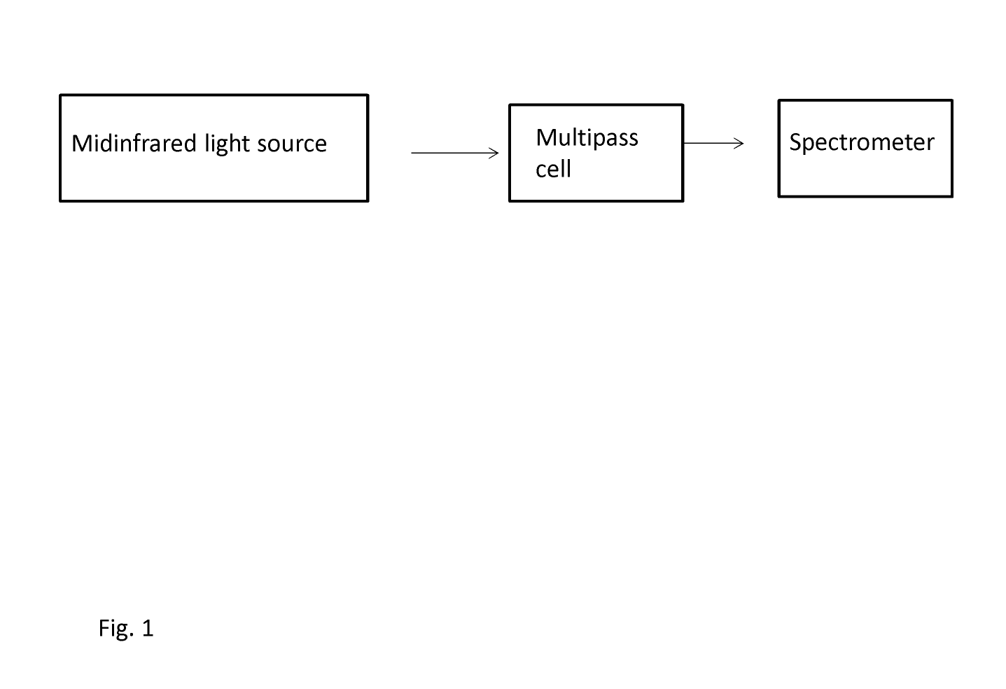

For high resolution spectroscopy applications, a low cost optical spectroscopy method that can for example detect trace gases with an instrument in a compact form factor is very much sought. A simple configuration for high sensitivity spectroscopy can be based on the use of a multi-pass cell; an example of a basic configuration is shown in FIG. 1. A multipass cell directs an input light beam several times through a gas within the cell by using curved mirrors to reflect the beam back and forth for many passes before the beam leaves the cell. The beam path length in commercially available multipass cells may be 1 to 1000 m, depending on cell size and configuration. Sample gases can then easily be pumped into the gas cell for analysis. After transmission through the gas cell a Fourier Transform Infrared (FTIR) spectrometer or another spectrometer can be used for further analysis. Such spectrometers can also be used in conjunction with cavity enhanced spectroscopy for even higher sensitivity.

As shown in FIG. 1, spectrometers attached to the multi-pass cell are used for spectroscopic analysis. Conventional FTIRs, as well known in the art can for example be used.

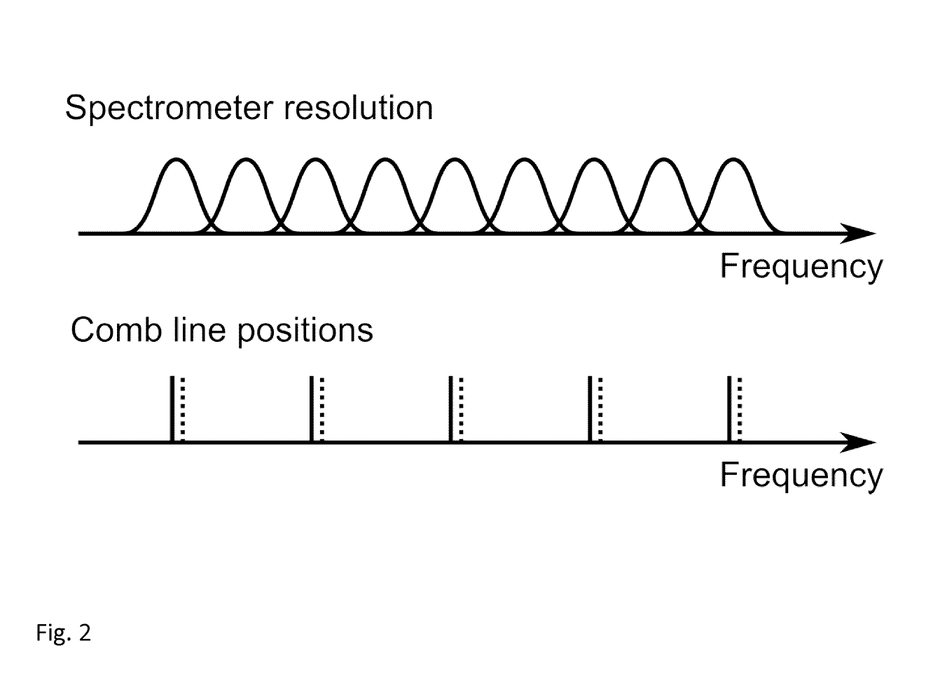

For spectroscopic analysis, a frequency resolution equivalent to the ruler or comb line width can be obtained by slowly scanning the comb spacing or carrier envelope offset frequency of the frequency ruler or comb, and detecting with a resolution approximately twice higher than the repetition rate of the frequency ruler or comb, sufficient to separate individual comb lines. This results in a frequency resolution that is several orders of magnitude better than the frequency resolution of the detection system with a standard light source. An example of this principle is illustrated in FIG. 2. The spectrometer response (for example a FTIR or grating spectrometer) has spectral pixels with a resolution much broader than the comb linewidth. The spectrometer response is schematically shown as the overlapping bell curves in the upper figure and the comb linewidth is schematically shown as the vertical lines in the lower figure. With a resolution two -or more- times the comb repetition rate, the system will report similar measurements for the two combs shown by the solid or the dashed lines. However, since the comb line positions are well known from accurate measurements of the repetition rate fᵣₑₚ and f₀ (the carrier envelope offset frequency) the frequency of the light being measured in a spectrometer pixel is known, and has the same narrow linewidth of the frequency comb.

It has been shown that a frequency comb can be scanned in repetition rate by adjusting the laser cavity length with a piezoelectric transducer, while maintaining a locked f₀, but without maintaining a phase lock of the repetition rate (e.g., Washburn et al., Opt. Express, vol. 12, 4999, (2004)). For detection methods that utilize a stable light source, such as Fourier transform spectroscopy, it is preferred that the comb can be scanned in steps while maintaining locked f₀ as well as locked repetition rate, fᵣₑₚ.

The optimal method of scanning the midinfrared frequency comb depends on the type of light source and the method of frequency comb stabilization. In the example of a doubly resonant non-degenerate optical parametric oscillator OPO (DNOPO), a convenient method of stabilization is to lock the beat frequency between the frequency doubled DNOPO output, and a continuous-wave stable reference laser. Frequency doubled OPO output is often available directly from the OPO from parasitic nonlinear processes within the OPO, or a nonlinear crystal such as periodically-poled lithium niobate can be used to generate the doubled frequency. Doubled OPO output is near the pump laser in wavelength, so that both the pump and OPO can be stabilized to the same reference laser.

For example, a Tm-fiber laser has output at 2 μm, which can be extended by supercontinuum generation to include the 1.5 μm region. The DNOPO can have a signal in the 3 μm region, and an idler in the 5 μm region. Frequency doubled DNOPO signal is then in the 1.5 μm telecom wavelength region, so that both the pump laser and DNOPO can be stabilized to easily available telecom narrow-linewidth lasers.

To scan the comb lines, a simple method can be used to tune the radio frequency to which the beat notes that stabilize the comb are locked. For many systems though, this method is limited in range due to problems when a beat note moves near another radio frequency feature, such as a mirrored version of the same beat note, or the laser repetition rate. While it is possible to mitigate these problems electronically, another scanning method avoids these problems by tuning the reference laser without changing the electronic locks.

When the pump laser has a stabilized f₀, and the pump laser is also stabilized to an optical reference, changing the frequency of the optical reference will change the repetition rate of the pump laser and consequently the repetition rate of the OPO. For the DNOPO, the change in reference frequency would ordinarily result in a change of f₀, but since the pump comb is locked to the same reference laser (using for example a parasitic output from the DNOPO), the result is that the f₀ of the DNOPO remains the same, e.g., the f₀ value of the DNOPO does not change if the reference laser frequency is changed. Since f₀ for a DNOPO is closely related to its spectrum because of dispersion, this method reduces or minimizes changes to the spectrum while scanning different values of the repetition rate. Thus, reference laser tuning allows smooth repetition rate scanning of all output combs by changing only one parameter, without interrupting any of the stabilization locks, and maintaining f₀. This in turn allows scanning of the comb lines through narrow band absorption features.

The method of reference laser tuning depends on the type of reference laser used. In the example of a narrow-linewidth telecom laser, a temperature-stabilized diode laser is used. The laser frequency can then be tuned by adjusting the temperature of the diode. The diode driving current can also be used as a control, which has a superior time response. Temperature and current control can be combined to provide sufficient wavelength range and good temporal control. The reference laser can be set and stabilized by a feedback loop, for example, the common proportional-integral-derivative method, that uses a measurement of the difference between the repetition rate of the laser, and the desired repetition rate as the error signal. This method does not require calibration of laser frequency as a function of the control parameter, and will generally increase the stability of the reference laser, since the repetition rate can be easily measured with high accuracy and precision using commonly available frequency counters which can be referenced to stable clock sources such as the global positioning system.

To access many or all frequencies with the comb, the comb line can utilize a tuning range of fᵣₑₚ. For example, using an OPO idler comb at 5 μm wavelength with a repetition rate of 400 MHz utilizes a range in repetition rate of 2.7 kHz. For a 1.5 um reference laser, that corresponds to a tuning range of 1.3 GHz, which is easily accessible.

An example of an option for comb resolved spectroscopy is a Fourier Transform Spectrometer (FTS), where the light is split and recombined with varying time delays between the two arms, while the resulting interference pattern is recorded, and Fourier transformed to retrieve the spectrum. An FTS has the advantage of very high detection bandwidth of several micrometers, limited only by the bandwidth of the beamsplitter, and the detectors used. An FTS has a significant cost benefit from using one or two single channel detectors rather than a one or two dimensional detector array. The frequency resolution of an FTS is determined by the optical path delay between its two arms. A path delay of X cm yields a frequency resolution of 1/X cm⁻¹. For example, using a modest translation stage of 20 cm length, and passing each arm four times on opposite sides of the stage provides a total path delay of 8×20 cm=160 cm, for a resolution of 187 MHz. This is sufficient for resolving frequency combs with repetition rates greater than about 300 MHz.

Given the discrete spectrum of a frequency comb, care may need to be taken when using a FTS. When the FTS does not resolve the comb spacing, the frequency comb is approximately continuous, so standard FTS analysis can be used. When the FTS resolution is near or better than the comb spacing, an analysis may be performed to determine which frequencies are extracted from the measured time-domain interferogram. In a standard fast Fourier transform algorithm, the calculated frequencies have periods given by the total time delay in the interferogram divided by integers from 1 to the number of points in the interferogram. In the general case, these frequencies will not match the frequency comb line positions. Reported experiments have solved this problem by using very long optical delays (e.g., Zeitouny et al. Ann Phys. 525, 437 (2013)) or using zero-padding to oversample the spectrum (e.g., Balling et al. Meas. Sci. Technol. 23 094001 (2012)), and interpolating to find the comb modes. However, unnecessarily long path delays greatly increase the cost and size of the system, make optical alignment more difficult, and excessive zero-padding and interpolating increases the computational cost of analysis.

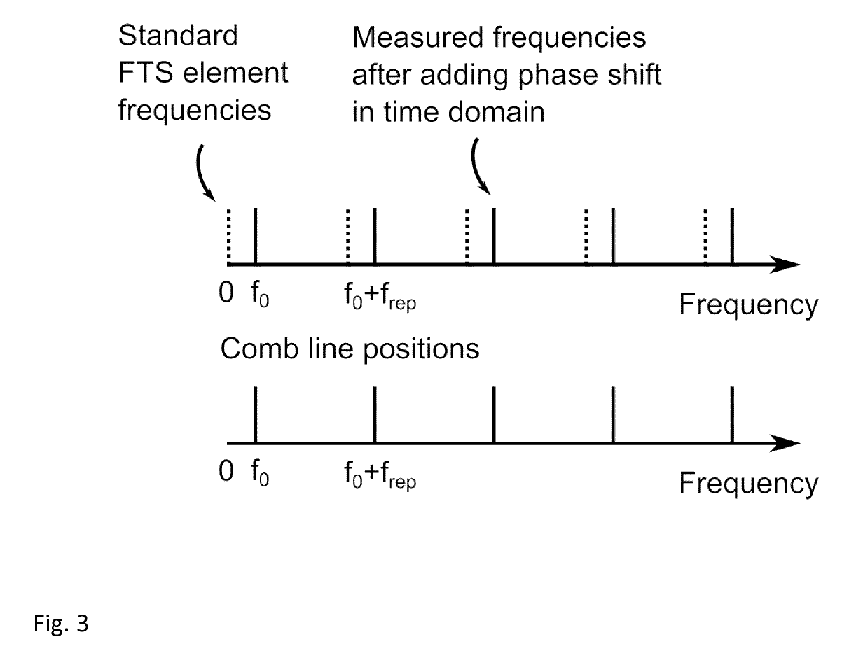

In some embodiments, it is preferable to have an optical delay close to 2 burst spacings, which allows clear comb resolution with minimal optical path delay. To match f₀ of the comb lines (at frequencies f₀+n fᵣₑₚ, where n=0, 1, 2, 3, 4, . . . ) and the frequency axis of a Fourier transform, the time domain interferogram can be multiplied by the linear phase e₀^{-i2πft}, where t is the time delay of the interferogram element. This linear phase shift in the time domain will cause a shift of the spectrum, so that the first element in the Fourier transform does not correspond to a frequency of 0 (leftmost dashed vertical line), but f₀ (leftmost solid vertical line) as illustrated in FIG. 3. The value of f₀ may be known from a separate measurement. If it is not known, it can be determined by maximizing the contrast between adjacent pixels as a function of f₀ using any optimization algorithm. This works because an incorrect phase shift results in the light from a comb line being shared amongst adjacent FTS frequency elements, rather than having the high contrast of a comb line in one pixel, and no comb line in the next pixel.

To match the FTS frequency axis to the comb spacing, the length of the time domain interferogram is chosen to be an integer multiple of the pulse spacing. The pulse spacing is visible on the interferogram as the spacing between interference bursts when pulses overlap with themselves, or neighboring pulses. If the interferogram length is equal to one burst spacing, the elements in the frequency domain will be spaced by one comb line. It is preferable in some implementations to have an interferogram length of two burst spacings. In this case, even numbered lines corresponds to comb lines, and odd numbered lines are dark, meaning that spectral power leakage from adjacent comb lines is low. Unlike the single burst spacing case, the contrast between even and odd numbered lines can be used to verify proper matching between the frequency comb and the FTS frequency axis. However, in some implementations, a single burst spacing may also be used or generally a interferogram length larger than or equal to a single burst spacing.

For interferogram lengths greater than one, but just below the next integer number of burst spacings, zero-padding (adding elements to the end of the interferogram with values of 0) can be used to increase the length to the next integer. This has the advantage of ensuring the correct frequency axis spacing, and the disadvantage of added noise due to the extra discontinuity in the interferogram. In most cases, the added noise from zero-padding is likely to be much less than other sources of noise in the spectrometer. This means that an FTS path delay greater than 1 burst spacing can provide comb resolved spectra.

An FTS generally measures the path delay by detecting fringes from a laser beam (e.g., HeNe) co-propagating with the measured light. Any angle between the two light paths and the different index of refraction for the two beams will cause a calibration error for the path delay and thus the frequency axis. Frequency combs provide a simple solution to this problem, as the interferogram will have at least two interference bursts, and their temporal spacing can be calibrated to the repetition rate of the laser, which can be measured to better than the stability of the repetition rate, and referenced to a stable clock, such as the global positioning system.

To accurately determine the spacing between interference bursts, since f₀ is generally non-zero, the shape of the bursts are different. To reliably assign a time in the interferogram to each burst, the interferogram can be converted into an envelope and a carrier by calculating the analytic representation of the time domain data. This can be done by taking a Fourier transform of the time domain interferogram. In the frequency domain, all negative frequency elements can be set to 0. The frequency domain data can be multiplied by 2 to retain total signal amplitude. An inverse Fourier transform can be used to return to the time domain, where the real component is the same as the original time domain interferogram, but there is now a matching imaginary component as well. The magnitude of this complex interferogram provides the envelope of the original interferogram. The center of the envelope can then be found by many common methods such as finding the maximum, taking a center of mass, or fitting to a peaked function such as a Gaussian. A method finding the point of stationary phase has also been reported (Balling et al. Meas. Sci. Technol. 23 094001 (2012)). These methods can be improved by using a filter in the frequency domain to isolate the contribution from a particular wavelength range, for example, the OPO idler without the signal. The length calibration intrinsically removes the average index of refraction of the selected spectrum, so that the resulting frequency axis is approximately the vacuum frequency. Dispersion may cause increasing discrepancy the further the frequency is from the average of the selected spectrum, but this will be a small difference in most applications.

In cases where independent frequency calibration is not required, known absorption lines can be used to calibrate the frequency axis. Depending on the accuracy requirements, absorption lines of atmospheric components may be sufficient. When the frequency is correctly calibrated in one part of the spectrum, the nearby spectral components will also be well-known from the comb lines, whose spacing is precisely known from a measurement of the repetition rate.

Optical spectroscopy as discussed above can be adapted for highly sensitive infrared (IR) absorption measurements, however, the cost and complexity can sometimes be prohibitive. As an alternative photo-acoustic spectroscopy can also be considered; for applications in breath analysis, particularly broadband photo-acoustic spectroscopy is of interest.

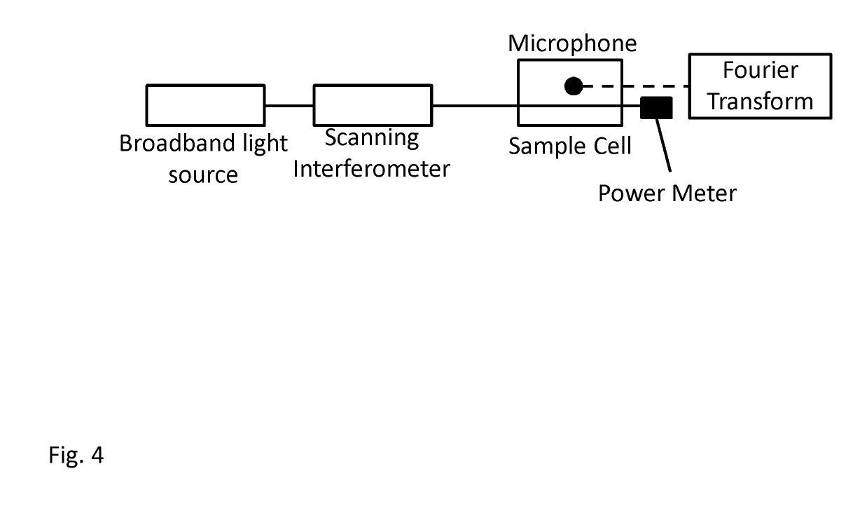

An example embodiment of a broadband photo-acoustic spectroscopy system is shown in FIG. 4. As a broadband light source, a fiber based supercontinuum source can be used, however, OPOs as well as optical parametric amplifiers (OPAs) as well as sources based on broadband mode locked lasers or amplified spontaneous emission can also be implemented, to name a few examples. These sources can be coherent or incoherent and do not need to have a defined comb structure.

In FIG. 4, the output light from the light source is sent through a scanning interferometer, a photo-acoustic sample cell and a power meter. The scanning interferometer modulates the source spectrum, so that the sample inside of the sample cell is excited by the modulated laser, and the sample produces sound waves that are detected by the microphone. The output of the microphone is an interferogram that can be converted into an absorption spectrum using a Fourier Transform. To calibrate the absorption data, two measurements can be made. First, a blank with the sample cell empty, and second, a measurement with a sample in the sample cell. The absorption from the filled sample cell is subtracted from the absorption caused by the blank to give an absorption spectrum.

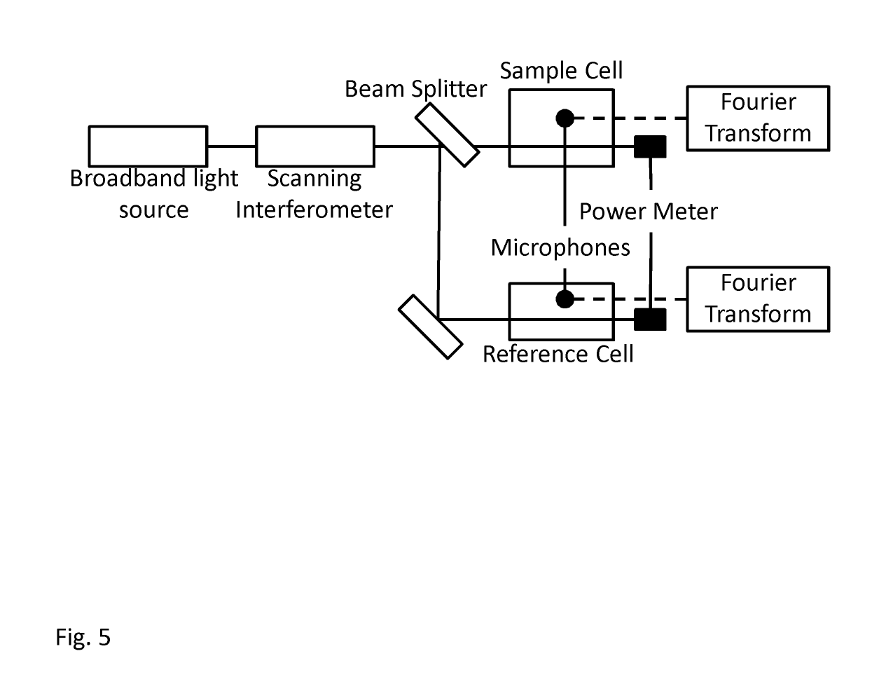

Inherent to any broadband light source are variations in the emission spectrum that can fluctuate in time. While collecting a “blank” spectrum before sample spectra are collected is a standard operation with broadband thermal sources, whose spectra are only dependent on the temperature stability of the light source, laser sources carry additional fluctuations, and the highest sensitivity and accuracy for thermal and laser sources is found when real-time differential photo-acoustic spectroscopy (PAS) occurs. An example of a differential PAS system is shown in FIG. 5. In FIG. 5, a beam-splitter is used to split the laser beam into two sections. One beam passes through the sample cell, and the other passes through an identical reference cell. The sample cell and the reference cell are substantially the same, with the difference between the two cells being that one contains a sample gas, and one contains a reference gas. For instance, if the sample had some dilution of a gas of interest in nitrogen, the reference cell would have nitrogen at the same pressure with no diluted gas inside. The absorption spectrum from the sample cell can be subtracted from the absorption spectrum from the reference cell, yielding a real-time absorption spectrum of the sample. Other implementations for differential photo-acoustic spectroscopy can also be used.

The modulation frequency generated in the photo-acoustic sample cell depends on the velocity of the stage in the scanning interferometer, the number of passes and the wavelength of light, as shown in the following equation: f=v/100λ, where v is the velocity of the stage in cm/s, interferometer, and λ is the wavelength of the light in meters. For a scan speed of 1 cm/s, and a wavelength between 2 and 5 p.m, the modulation frequency varies between 5 and 2 kHz. Higher modulation frequencies at the same mirror velocity are possible by using multi-pass configurations through the scanning interferometer.

The acoustic cell can be designed such that the windows are mounted at the nodes of the acoustic cell. Commercial gas photoacoustic cells are available from established photoacoustic companies such as Gasera, LTD, Turku, Finland (e.g., photoacoustic gas analysis module PA101). Commercial solid phase and liquid photoacoustic cells are available from MTEC Photoacoustics, INC, Ames, Iowa (e.g., photoacoustic detector accessory PAC300).

Generally similar to conventional FTIR spectroscopy, when using a comb source as the broadband light source, comb resolution can be achieved by having an FTIR scan range >1 times the cavity round trip length of the broadband light source. In other words for a broadband comb source operating at a repetition rate of 400 MHz, an FTIR scan range of >0.75 m or alternatively a scan range closer to 1.5 m can be utilized.

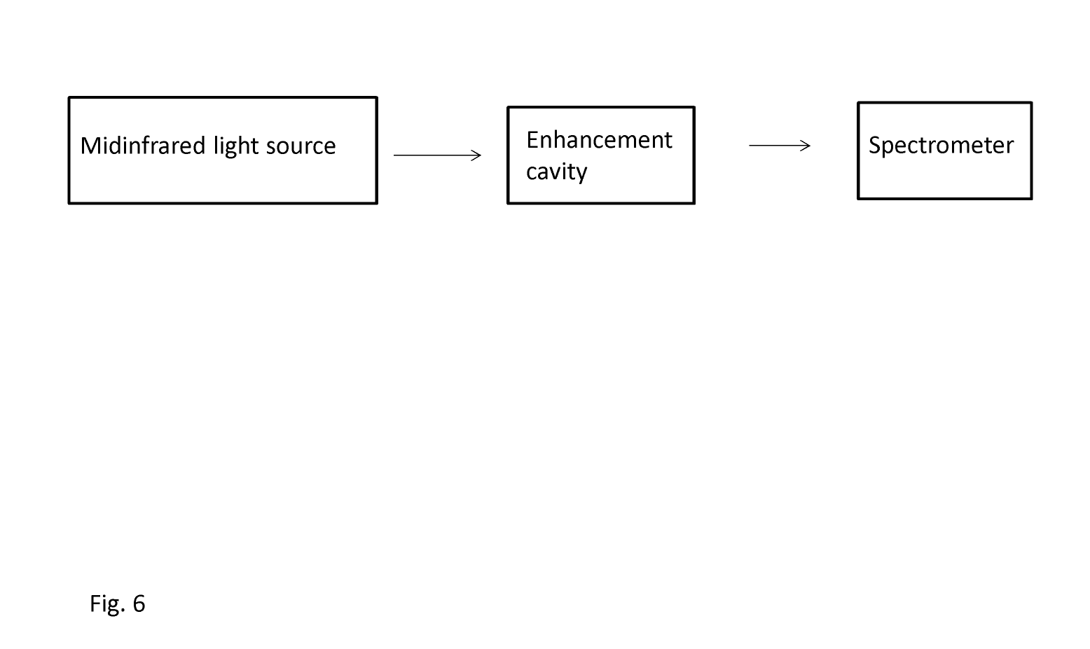

As discussed herein, high power supercontinuum sources can also be used in conjunction with a relatively simple cavity enhanced spectroscopy method as shown in FIG. 6. The system is generally similar to the one shown in FIG. 2, but the multi-pass cell is replaced with an enhancement cavity. Additional lenses (not shown) and delivery fibers (not shown), which may be single-or multi-mode, may be used to couple the light into and out of the cavity. In the mid-IR high power supercontinuum sources for example based on nonlinear frequency generation in fluoride fibers can be used; these supercontinuum sources do not need to be coherent. An FTS can be used to obtain comb resolved spectroscopy similar to the examples discussed herein. In these examples, the FTS scan range can be larger than the burst spacing in the cavity, (e.g., FTS scan range) greater than approximately c/Δf , where c is the velocity of light and Af is the frequency spacing between the transmission resonances of the cavity. Note that Δf can be chosen to be a multiple of the comb spacing of the upstream comb source, therefore, a very compact arrangement for comb resolved spectroscopy can be constructed.

Various advances in optical spectroscopy methods for trace gas detection have been discussed in the following example patents, published patent applications and publications. Embodiments disclosed herein may be usable with embodiments described in the following references.

Haensch et al., U.S. Pat. No. 6,897,959, entitled “Frequency comb analysis”;

Hartl et al., U.S. Pat. No. 7,809,222, entitled ‘Laser based frequency standards and their applications’;

Gohle et al., U.S. Pat. No. 8,120,773, entitled ‘Method and device for cavity enhanced optical vernier spectroscopy’;

Fermann et al., U.S. Pat. No. 8,120,778: entitled ‘Optical scanning and imaging systems based on dual pulsed laser systems’;

Giaccari et al. U.S. Patent Application Pub. No. 2011/0043815, entitled ‘Referencing of the Beating Spectra of Frequency Combs’;

Vodopyanov et al., U.S. Patent Application Pub. No. 2011/0058248, entitled ‘Infrared frequency comb methods, arrangements and applications’;

S. Diddams et al., ‘Molecular fingerprinting with the resolved modes of a femtosecond laser frequency comb’, Nature, vol. 445, pp. 627 (2007);

A. Foltynowicz et al., ‘Optical frequency comb spectroscopy’, Faraday Discussions, vol. 150, pp. 23-31, 2011;

Picqué et al. U.S. Patent Application Pub. No. US2011/0261363, entitled: “Fourier transform spectrometer with a frequency comb light source”.

J. B. Paul, L. Lapson, and J. G. Anderson, ‘Ultrasensitive absorption spectroscopy with a high-finesse optical cavity and off-axis alignment’, Applied Optics, vol. 40, 4904 (2001);

J. M. Langridge et al. ‘Cavity enhanced absorption spectroscopy of multiple trace gas species using a supercontinuum radiation source’, Optics Express, vol. 16, 10178 (2008);

Balling et al., ‘Length and refractive index measurement by Fourier transform interferometry and frequency comb spectroscopy’, Meas. Sci. Technol.,Vol. 23, 094001 (2012);

Zeitouny et al., ‘Multi-correlation Fourier transform spectroscopy with the resolved modes of a frequency comb laser’, Ann. Phys., Vol. 525, 437 (2013);

Fermann et al., U.S. Patent Application Pub. No. 2014/0264031, entitled: ‘Trace gas detection system’;

Fermann et al., PCT International Application Publication No. WO 2013/148757, entitled: ‘Methods for precision optical frequency synthesis and molecular detection’;

P. Malara, M. F., Witinski, F., Capasso, J. G., Anderson, and P. De Natale, ‘Sensitivity enhancement of off-axis ICOS using wavelength modulation’, Applied Physics B, vol. 108, pp. 353-359 (2012); and

Washburn, B. R., et al., “Fiber-laser-based frequency comb with a tunable repetition rate,” Opt. Exp., Vol. 12, Issue 20, pp. 4999-5005, Oct. 4, 2004.

Thus, the disclosure has been described in several embodiments. It is to be understood that the embodiments are not mutually exclusive, and elements described in connection with one embodiment may be combined with, or eliminated from, other embodiments in suitable ways to accomplish desired design objectives. No single feature of group of features is necessary or indispensable for each embodiment.

For purposes of summarizing the present disclosure, certain aspects, advantages and novel features are described herein. It is to be understood, however, that not necessarily all such advantages may be achieved in accordance with any particular embodiment. Thus, the present disclosure may be embodied or carried out in a manner that achieves one or more advantages without necessarily achieving other advantages as may be taught or suggested herein.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” or “an” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), or both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present.

Thus, while only certain embodiments have been specifically described herein, it will be apparent that numerous modifications may be made thereto without departing from the spirit and scope of the disclosure. Further, acronyms are used merely to enhance the readability of the specification and claims. It should be noted that these acronyms are not intended to lessen the generality of the terms used and they should not be construed to restrict the scope of the claims to the embodiments described therein.

What is claimed is:

1) An optical spectroscopy system for the detection of comb resolved spectra comprising:
a comb source comprising individual comb lines with a comb spacing Δf; and
a Fourier transform spectrometer with a scan range such that c/Δf less than approximately the scan range,
where c is the velocity of light and where spectral sampling points of said Fourier transform spectrometer are selected to match at least some of the individual comb lines of said comb source.

2) An optical spectroscopy system for the detection of comb resolved spectra comprising:
a comb source comprising individual comb lines with a comb spacing Δf;
a scanning Fourier transform spectrometer with a scan range greater than approximately c/Δf; and
a photo-acoustic gas cell or photo-acoustic detection system.
